(19) United States
(12) Patent Application Publication
(10) Pub. No.: US 2025/0110783 A1
(43) Pub. Date: Apr. 3, 2025

(54) ROLE-BASED MULTI-CONTROLLER COLLABORATION ON RESOURCE MODIFICATION IN A CONTAINER ORCHESTRATION PLATFORM

(71) Applicant: INTERNATIONAL BUSINESS MACHINES CORPORATION, Armonk, NY (US)

(72) Inventors: Ying Mo, BEIJING (CN); Guangya Liu, Cary, NC (US); Zhi Li, BEIJING (CN); Yan Wei Li, Beijing (CN); Hou Fang Zhao, Beijing (CN); Yao Chen, Beijing (CN); Xiaoli Duan, Beijing (CN)

(21) Appl. No.: 18/374,043

(22) Filed: Sep. 28, 2023

(51) Int. Cl. G06F 9/50

(52) U.S. Cl. CPC G06F 9/5027

(57) ABSTRACT

A method, computer program product, and computer system for generating and using a layering resource representation of a resource in a container orchestration platform. An owner controller creates a base layer of the layering resource representation. The base layer is a resource field tree of the entire resource. After the base layer is created, one or more collaborator controllers create respective one or more overlay layers of the layering resource representation. Each overlay layer is a sub-tree of the resource field tree. Each collaborator controller is authorized to update each field of the sub-tree created by each collaborator controller and is not authorized to update any other field of the resource field tree. Any field of the sub-tree that is updated by the collaborator controller that created the sub-tree replaces any previous updating of any field by the owner controller.

### BACKGROUND

The present invention relates to resource modification, and more specifically to conflict avoidance during resource modification.

### SUMMARY

Embodiments of the present invention provide a method, a computer program product, and a computer system for generating and using a layering resource representation of a resource in a container orchestration platform. An owner controller creates, using one or more processors of a computer system, a base layer of the layering resource representation, wherein the base layer consists of a resource field tree of the entire resource. After the base layer has been created, one or more collaborator controllers create, using the one or more processors, respective one or more overlay layers of the layering resource representation, wherein each overlay layer consists of a sub-tree of the resource field tree. Each collaborator controller is authorized to update each field of the sub-tree created by said each collaborator controller and is not authorized to update any other field of the resource field tree. Any field of the sub-tree that is updated by the collaborator controller that created the sub-tree replaces any previous updating of said any field by the owner controller.

### BRIEF DESCRIPTION OF THE DRAWINGS

FIG. 1A depicts a scenario in which a second controller attempts to modify a deployment resource created by a first controller who is an owner that created the deployment resource, in accordance with the prior art.

FIG. 1B depicts a scenario in which a second controller attempts to delete or scale down a deployment resource created by a first controller who is an owner that created the deployment resource, in accordance with the prior art.

FIG. 1C depicts a scenario in which both a first controller and a second controller 20 attempt to modify a resource, in accordance with the prior art.

FIG. 2 is a diagram illustrating multi-controller collaboration by an owner controller and one or more collaborator controllers on a resource, in accordance with embodiments of the present invention.

FIG. 3 depicts an extension to Role-Based Access Control (RBAC) for allowing a user to specify a partial update or patch at a resource field level using a JavaScript Object Notation (JSON) Path expression, in accordance with embodiments of the present invention.

FIG. 4A depicts a layering resource representation of the resource field tree of a resource, in accordance with embodiments of the present invention.

FIG. 4B is a flow chart of a method for generating a layering resource representation of a resource, in accordance with embodiments of the present invention.

FIG. 4C is a flow chart of a process for storing the resource as a layering resource representation of the resource in a key-value database denoted as an etcd database, in accordance with embodiments of the present invention.

FIG. 5A depicts a process for reading a resource, in accordance with embodiments of the present invention.

FIG. 5B is a flow chart describing the process of FIG. 5A for reading the resource, in accordance with embodiments of the present invention.

FIG. 6 is a flow chart of a process for creating, and saving into the etcd database, a base layer of a resource, in accordance with embodiments of the present invention.

FIG. 7 is a flow chart of a process for creating, and saving into the etcd database, an overlay layer of a resource, in accordance with embodiments of the present invention.

FIG. 8 is a diagram describing detection of changes in a resource using the etcd Watch function, in accordance with embodiments of the present invention.

FIG. 9A is a diagram illustrating tracking of a layering resource representation lifecycle pertaining to deleting overlay layers of the resource, in accordance with embodiments of the present invention.

FIG. 9B is a flow chart describing a process of releasing a collaborator controller, in accordance with embodiments of the present invention.

FIG. 10 is a flow chart of a process for conditionally creating, and saving into the etcd database, a base layer of a resource, in accordance with embodiments of the present invention.

FIG. 11 is a flow chart of a process for conditionally creating, and saving into the etcd database, an overlay layer of a resource, in accordance with embodiments of the present invention.

FIG. 12 illustrates a computer system, in accordance with embodiments of the present invention.

FIG. 13 depicts a computing environment which contains an example of an environment for the execution of at least some of the computer code involved in performing the inventive methods, in accordance with embodiments of the present invention.

### DETAILED DESCRIPTION

According to an aspect of the invention, an owner controller creates, using one or more processors of a computer system, a base layer of the layering resource representation, wherein the base layer consists of a resource field tree of the entire resource. After the base layer has been created, one or more collaborator controllers create, using the one or more processors, respective one or more overlay layers of the layering resource representation, wherein each overlay layer consists of a sub-tree of the resource field tree. Each collaborator controller is authorized to update each field of the sub-tree created by said each collaborator controller and is not authorized to update any other field of the resource field tree. Any field of the sub-tree that is updated by the collaborator controller that created the sub-tree replaces any previous updating of said any field by the owner controller. The preceding aspect of the invention advantageously avoids conflict when two or more controllers attempt to modify a same resource and prevents one controller overwriting a change to a resource previously made by another controller.

In embodiments, the one or more overlay layers consist of N overlay layers, wherein N is at least 1, and wherein the method further comprises: storing, by the one or more processors, the layering resource representation of the resource in a key-value database denoted as an etcd database. Storing the layering resource representation of the resource comprises: generating a base layer resource key that maps to the owner controller and is unique to the base layer; storing the base layer into the etcd database, using the base layer resource key; generating, for overlay layer n of N overlay layers, an overlay layer resource key (Kn) that maps to the collaborator controller of overlay layer n and is unique to overlay layer n (n=1, 2, . . . , N); and storing overlay layer n in the etcd database using the overlay layer resource key (Kn) (n=1, 2, . . . , N). The preceding embodiments have a technical feature of using a separate base layer and separate overlay layers to store the resource using unique resource keys that map to independent, different controllers. The preceding embodiments advantageously allow multiple controllers, including the owner controller and collaborator controllers, to collaborate on the same resource in a non-conflicting manner.

In embodiments, storing the base layer into the etcd database is initiated by a Application Programming Interface (API) call, and wherein said storing the base layer into the etcd database comprises: obtaining an identification of a user Service Account from an API token included in the API call; obtaining permission, from Role-Based Access Control (RBAC), to create the resource; determining, from RBAC, that the resource can be stored by the user Service Account; and saving the resource in the etcd database as the base layer using the base layer resource key. The preceding embodiments advantageously use RBAC to authorize creating and storing the resource, which enables storing the base layer of the resource.

In embodiments, the method further comprises: after said determining that the resource can be stored by the user Service Account and before said saving the resource in the etcd database as a base layer: obtaining a field manager for the resource from resource metadata; and determining either that the field manager exists in the API call and that the field manager in the API call equals the user Service Account or that the field manager does not exist in the API call. The preceding embodiments advantageously use satisfaction of the preceding constraint on the fieldManager parameter in the API call to save the base layer in the etcd database.

In embodiments, storing overlay layer n (n=1, 2, . . . , N) in the etcd database is initiated by a Application Programming Interface (API) call, and wherein said storing overlay layer n into the etcd database comprises: obtaining an identification of the user Service Account from an API token included in the API call; obtaining permission, from Role-Based Access Control (RBAC), to create the resource; extracting a sub-tree of overlay layer n from a JavaScript Object Notation (JSON) path defined in RBAC rules; constructing the overlay layer resource key (Kn) for overlay layer n, using the JSON path defined in RBAC rules; and saving the resource sub-tree in the etcd database as overlay layer n, using the overlay layer resource key (Kn). The preceding embodiments advantageously use RBAC to authorize creating and storing the resource, which enables storing an overlay layer of the resource.

In embodiments, the method further comprises: after said constructing the overlay layer resource key (Kn) for overlay layer n and before said saving the resource sub-tree in the etcd database: obtaining a field manager for the resource from resource metadata; and determining either that the field manager exists in the API call and that the field manager in the API call equals the user Service Account or that the field manager does not exist in the API call. The preceding embodiments advantageously use satisfaction of the preceding constraint on the fieldManager parameter in the API call as a necessary condition for saving overlay layer n (n=1, 2, . . . , N) in the etcd database.

In embodiments, the method further comprises: reading, by a user Service Account, using the one or more processors, the resource from the etcd database Reading the resource is initiated by an Application Programming Interface (API) call and comprising: obtaining an identification of the user Service Account from an API token included in the API call; obtaining permission, from Role-Based Access Control (RBAC), to access the resource; determining, from RBAC, that the resource can be accessed by the user Service Account; accessing the base layer from the etcd database using the base layer resource key; for n=1, 2, . . . , N: accessing overlay layer n from the etcd database using the overlay layer resource key (Kn); and merging overlay layer n with the base layer, including overriding values of sub-fields in the base layer by respective sub-field values in overlay layer n. The preceding embodiments advantageously merge all the layer representations retrieved from the etcd database layer by layer, starting from the base layer that maps to the owner controller, and continuing with the overlay layers individually, with each overlay layer mapping to a collaborator controller. The fields in the overlay layer will overrides the corresponding fields in the base layer. Thus, the client who requests the resource will see the fields controlled by collaborator controllers as well as all the other fields controlled by the owner controller as a merged view.

In embodiments, the method further comprises: employing, by the owner controller and the collaborator controller authorized to update the resource fields of overlay layer n using the one or more processors, an etcd Watch function to independently monitor the base layer and overlay layer n for changes in the base layer and the overlay layer n, respectively (n=1, 2, . . . , N). Before the layering resource representation is introduced for embodiments of the present invention, if multiple controllers are watching the same resource, changes to that resource will trigger all the controllers, which leads to conflict. With the layering resource representation for embodiments of the present invention, as each controller has its own resource representation to watch, changes made to the resource, depending on which fields are being affected, only the corresponding controller will be notified; hence, no conflict will occur.

In embodiments, a managedFields data structure includes metadata specific to the owner controller and metadata specific to the collaborator controller of overlay layer m (m=1, 2, . . . , N), and wherein the method further comprises: releasing, by the one or more processors, the collaborator controller of overlay layer m, wherein m is selected from the group consisting of 1, 2, . . . , and N; and in response to said releasing, removing, by the one or more processors, the metadata specific to the collaborator controller of overlay layer m from the managedFields data structure. The preceding embodiments advantageously provide a technical mechanism, using the managedFields feature, for deleting individual overlay layers, which has the advantage being able to selectively release individual layers while retaining the remaining non-deleted overlay layers.

In embodiments, the one or more overlay layers consist of two or more overlay layers, and wherein the two or more overlay layers are mutually exclusive with respect to the fields in the two or more overlay layers. The preceding embodiments advantageously provide for the independence and individuality of the overlay layers.

In embodiments, wherein an extension to a Role-Based Access Control (RBAC) includes a field that defines each collaborator controller and authorizes each collaborator controller to update, by patching, the fields of the sub-tree that each collaborator controller creates. The preceding embodiments provide a technical feature of extending RBAC to provide an advantage of enabling the updating of sub-trees of fields in overlay layers of the resource.

In embodiments, the method further comprises: role binding, by the one or more processors, a user Service Account to a controller role of one of the collaborator controllers via metadata that links the user Service Account to the controller role. The preceding embodiments provide a technical feature of role binding a user Service Account to a controller role of one of the collaborator controllers via metadata, which advantageously enables the collaborator controller to update an overlay layer without affecting the other layers of the layering resource representation.

Embodiments of the present invention pertain to, inter alia, generating and using a layering resource representation of a resource in a container orchestration platform. In various embodiments, the container orchestration platform includes a Kubernetes platform. The various embodiments described herein with reference to a Kubernetes platform are not limited to a Kubernetes platform and are generally applicable to any currently known or later developed container orchestration platform. Kubernetes (aka K8s; i.e., 8 letters between “K” and “s”) is an open source system to deploy, scale and manage containerized applications.

A Kubernetes Application Programming Interface (API) is a front end of the Kubernetes control plane. The Kubernetes API communicates interactions with a computer or system to retrieve information or perform a function.

A Kubernetes API server handles resources such as, inter alia, a central processing unit (CPU), memory, pods, services, etc. and can also handle custom resources (CRs) through Custom Resource Definitions (CRDs). A CR is an extension of the Kubernetes API that allows storing API objects and lets the API Server handle the lifecycle of the CR. Kubernetes clusters maintain the resources and assign the resources to running containers.

An API call (GET, PUT, PATCH, etc.) may include an API token to identify and authenticate a user of a resource associated with the API call.

Kubernetes uses a key-value database, called “etcd”, to store objects such as, inter alia, resource definitions and uses the Kubernetes API server to communicate with etcd. A resource key is an identification string unique to an object stored in etcd and is used to identify the object.

A Kubernetes cluster is a set of nodes for running containerized applications, each node being a compute machine.

A Kubernetes namespace is a mechanism for organizing clusters into virtual sub-clusters. A cluster may encompass multiple namespaces logically separated from each other and capable of communicating with each other. Namespaces cannot be nested within each other. Kubernetes Role-Based Access Control (RBAC) serves to regulate access to resources based on Roles of users. A Role is an action defined by a verb (e.g., get, list) that acts on a resource defined by a noun (e.g., pod, volume). Role binding is a mapping between a user (i.e., an individual or a group) and a particular Role. For example, a Role binding may assign a “pod-reader” Role to a user (named Service Account) within the “default” namespace which allows Service Account to read pods in the “default” namespace.

A Kubernetes controller is an entity that monitors resources and watches the state of a cluster.

Kubernetes built-in controllers include, inter alia: Namespace controller (performs tasks related to creating and deleting namespaces; Service accounts controller (creates default accounts and API access tokens for new namespaces); deployment controller (provides declarative updates for pods).

A Kubernetes resource is structured as a hierarchical configuration of resource fields. A resource field is a resource attribute. Table 1 presents an example of a pod resource represented as a manifest in YAML format.

TABLE 1

```
apiVersion: v1
kind: Pod
metadata:
  name: nginx
spec:
  containers:
  - name: nginx
    image: nginx:1.14.2
    ports:
    - containerPort: 80
```

The pod resource in Table 1 includes top-level fields of: “apiVersion”, “kind”, “metadata”, and “spec”. Some fields may have nested fields; e.g.: the field “spec” has a sub-field “containers”, and “containers” has sub-fields of “name”, “image”, and “ports”, and “ports” has a sub-field of “containerPort”.

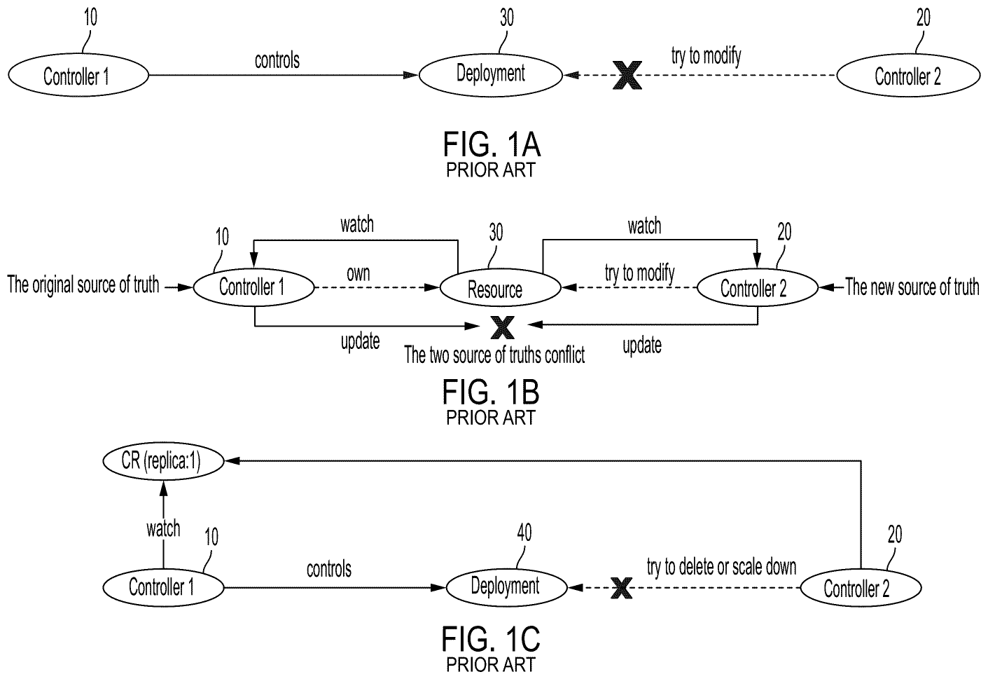

In practice, a conflict may arise if two controllers attempt to perform operations on a same resource (e.g., a same Kubernetes resource), as illustrated in FIGS. 1A, 1B and 1C.

FIG. 1A depicts a scenario in which a second controller 20 (denoted as Controller 2) attempts to modify a deployment resource 30 created by a first controller 10 (denoted as Controller 1) who is an owner that created the deployment resource 30, in accordance with the prior art. The deployment resource 30 pertains to deployment of a resource. The attempt by Controller 2 to modify the deployment resource 30 fails, since any change made by Controller 2 will be negated (i.e., reversed) by Controller 1 quickly because Controller 1 is the owner who owns the status of the deployment, and Controller 1 is not aware of any other controller who may want to modify the deployment resource 30. Thus, any change that is not aligned with what is expected by Controller 1 will be treated as status drift and will be overridden by Controller 1 based on a reconciliation mechanism (e.g., a Kubernetes reconciliation mechanism).

FIG. 1B depicts a scenario in which the second controller 20 (Controller 2) attempts to delete or scale down the deployment resource 30 controlled, via a CR, by the first controller 10 (Controller 1) who is an owner that created the deployment resource 30, in accordance with the prior art. The deployment resource 30 pertains to deployment of a resource. However, the attempt by the Controller 2 to delete or scale down the deployment resource 30 will fail by touching the deployment resource 30 directly, since Controller 2 does not know that Controller 2 has to manipulate the CR to delete or scale down the deployment resource 30.

FIG. 1C depicts a scenario in which both a first controller 10 (Controller 1) and a second controller 20 (Controller 2) attempt to modify a resource 40, in accordance with the prior art. However, an attempt by the two controllers (i.e., Controller 1 and Controller 2) to modify the same resource 40 (e.g., in Kubernetes) will encounter a conflict, because only one controller of the two controllers wins, or none of the two controllers wins.

For the scenario of FIG. 1C, an issue is that changes to the resource 40 made by a subsequent controller will usually be negated (i.e., reversed) by the previous controller to prevent unintentional overwriting, because the previous controller owns the resource, or even worse, the resource 40 will keep being updated by the two controllers alternately because each controller considers itself to have sole authority modify the resource 40, which leaves the system in an uncertain status and wastes a significant quantity of compute resources.

The preceding issue for the scenario of FIG. 1C can often be seen in many other scenarios in the real world; e.g., modify a deployment CPU and memory for custom sizing, auto-change a pod replica by Auto-Scaler, update a Kubernetes resource by syncing configuration from git repo in GitOps, or more specifically, some ARM solution. For example, Turbonomic may attempt to update whatever Kubernetes resources in a cluster that Turbonomic monitors for the purpose of resource optimization and this update attempt will also fail for the same reason (i.e., both GitOps and Turbonomic consider themselves to have sole authority to modify resource 40). GitOps is a workflow pattern for managing modern cloud infrastructure in Kubernetes cluster management. Turbonomic software automatically sizes containers, moves pods and scales clusters, helping to ensure optimizing Kubernetes for performance and cost efficiency.

Embodiments of the present invention allow a controller who owns a resource to be able to define fine-grained RBAC rules so that another controller can update all fields or some fields of the resource when the other controller is in a role of a collaborator, which allows multiple controllers including the owner controller to collaborate on the same resource (e.g., the same Kubernetes resource). The preceding embodiments may involve: (i) defining field level RBAC rules for collaborator controllers; (ii) storing multiple representations for a resource in etcd, with one representation for each controller, and constructing a merged view by layering the representations; and/or (iii) managing the representation lifecycle using additional metadata attached to the resource.

Embodiments of the present invention utilize multi-controller collaboration on the same resource at a resource field level based on role as a fine-grained resource management model to avoid any conflict when multiple controllers accessing the same resource.

The layering resource representation supports the role-based multi-controller collaboration model that: (i) uses multiple resource representations with different keys to reflect the resource status for each controller; (ii) creates, updates, and watches a resource per the resource representation, and (iii) reads a resource by merging multiple representations into a single complete view.

Embodiments of the present invention track a layering resource representation lifecycle by adding metadata to the resource.

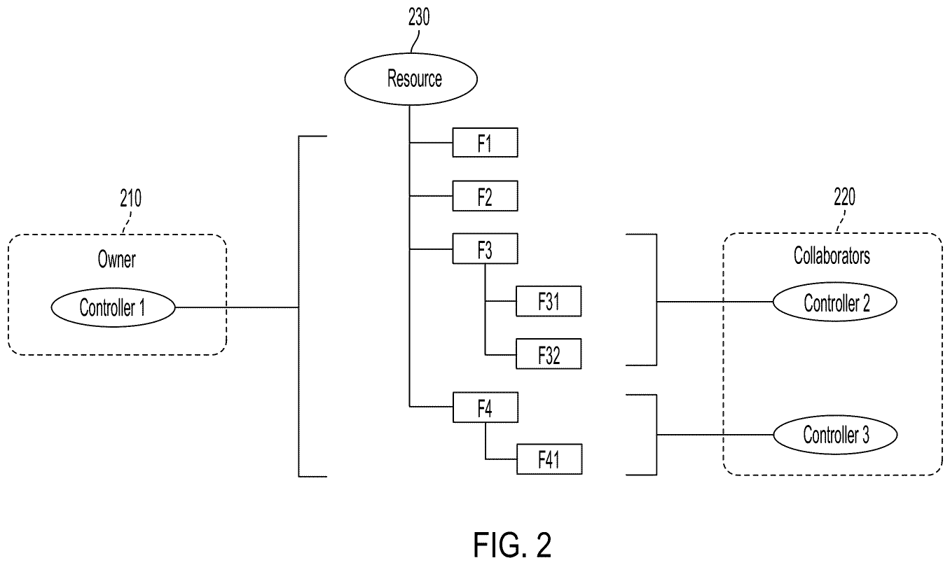

FIG. 2 is a diagram illustrating multi-controller collaboration by an owner controller 210 and one or more collaborator controllers 220 on a resource 230, in accordance with embodiments of the present invention. In one embodiment, the resource 230 is a resource of a container orchestration platform (e.g., a Kubernetes resource).

Both the owner controller 210 and the one or more collaborator controllers 220 are roles.

The resource 230 comprises a hierarchical tree which is a resource field tree consisting of: (i) top-level fields F1, F2, F3, and F4; (ii) fields F31 and F32 which are sub-fields of field F3; and (iii) field F41 which is a sub-field of field F4.

The owner controller 210, denoted as controller 1, is authorized to update all fields of the resource 230 by default.

The one or more collaborators 220 includes controller 2 and controller 3.

Controller 2 is authorized to update all fields of a sub-tree consisting of fields F3, F31 and F32.

Controller 3 is authorized to update all fields of a sub-tree consisting of fields F4 and F41.

A sub-tree is defined a subset of fields of the resource field tree of the resource, wherein the subset cannot include all fields of the resource field tree of the resource.

Generally, a collaborator controller is authorized to update all fields, or some fields of a sub-tree of the resource as needed.

Only the owner controller can create the whole resource which encompasses the resource field tree. Accordingly, being allowed to create the whole resource is a defining characteristic of an owner controller.

A collaborator controller cannot create a whole resource and is authorized to update only the resource fields of an overlay layer created by the collaborator controller.

An overlay layer is defined as a sub-tree of the resource field tree of the resource that includes fewer resource fields than all resource fields of the resource field tree of the resource. Accordingly, not being allowed to create the whole resource is a defining characteristic of a collaborator controller.

Each resource field can be controlled (including being updated) by only one controller, either a collaborator controller or the owner controller.

The collaborator controller can fill only those resource fields controlled by the collaborator controller, which will override the field values previously filled by the owner controller.

A collaborator controller can release control of those resource fields controlled by the collaborator controller. After those resource fields have been released, the owner controller will take over the control of those released resource fields.

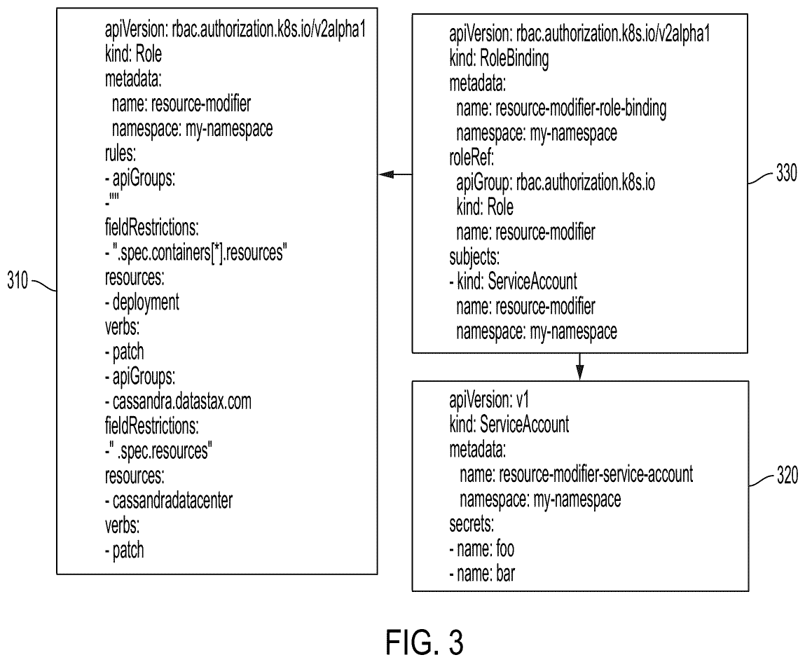

FIG. 3 depicts an extension to Role-Based Access Control (RBAC) for allowing a partial update or patch at a resource field level using a JavaScript Object Notation (JSON) Path expression, in accordance with embodiments of the present invention.

FIG. 3 includes a role description 310 which includes the RBAC extension, a user description 320, and a role binding description 330. The role description 310 describes a controller role called “resource-modifier” which is a collaborator controller. The user description 320 describes a user called “ServiceAccount”. The role binding description 330 describes the role binding of the user “ServiceAccount” to the controller role “resource-modifier” via metadata named “resource-modifier-service-account”.

The RBAC extension in the role description 310, which supports multi-controller collaboration on resource fields, introduces a rule of “fieldRestrictions” which informs the system that the controller in this role is allowed to modify the resources of all containers defined in a deployment spec resource field or the resources in a spec resource field of a custom resource called “cassandradatacenter”.

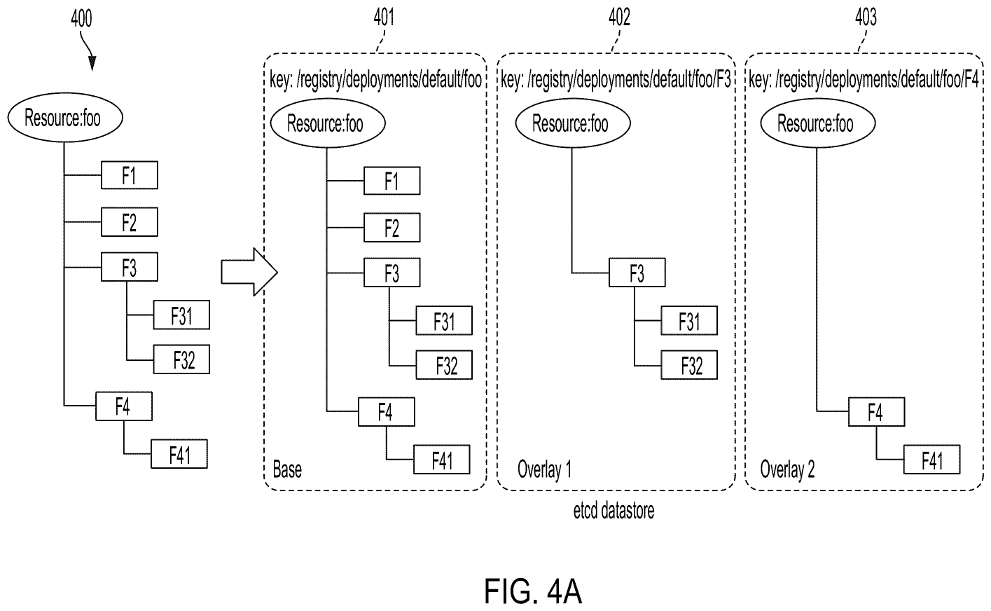

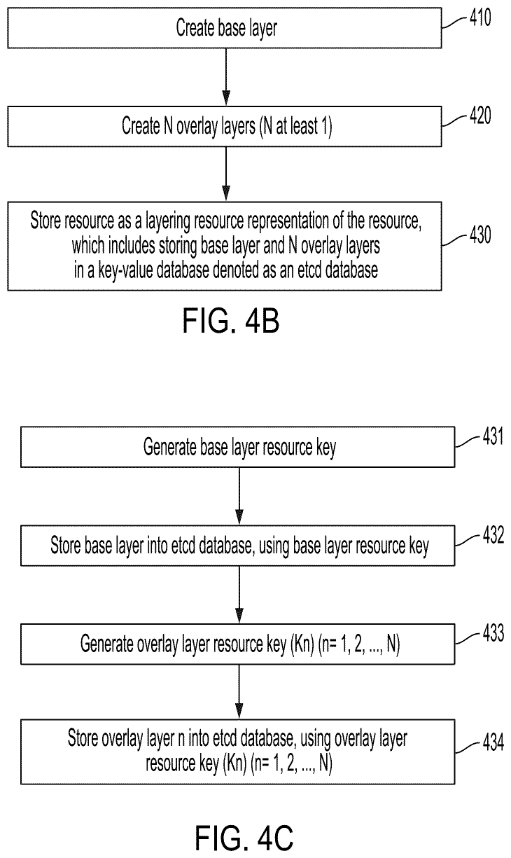

FIG. 4A depicts a layering resource representation of the resource field tree of a resource “foo”, in accordance with embodiments of the present invention. The resource “foo” is a deployment in a default namespace.

The resource field tree 400 is a conventional hierarchical representation of resource fields F1, F2, F3, F31, F32, F4, and F41. The resource field tree 400 is converted, in accordance with embodiments of the present invention, into the layering resource representation comprising a base layer (denoted as “base”) 401 and overlay layers 402 and 403 (denoted as overlay 1 and overlay 2).

Generally, the layering resource representation comprises one or more overlay layers. If the one or more overlay layers consist of two or more overlay layers, then the two or more overlay layers are mutually exclusive, and thus non-overlapping, with respect to the fields in the two or more overlay layers. Accordingly, each field the resource cannot exist in more than one overlay layer.

The base layer 401 comprises the entire resource field tree. Overlay 1 is a sub-tree 402 consisting of top-level field F3 and sub-fields F31 and F32. Overlay 2 is a sub-tree 403 that includes top-level field F4 and sub-field F41.

The resource field tree of the base layer 401 and the sub-tree of each overlay layer is stored in the etcd database with a unique resource key. The base layer 401 maps to the owner 210 (see FIG. 2) who is responsible to update all fields the base layer 401 as well as the entire resource. Overlay 1 maps to controller 1 who is a collaborator controller responsible for updating overlay 1 (i.e., fields F3, F31 and F32). Overlay 2 maps to controller 2 who is a collaborator controller responsible for updating overlay 2 (i.e., field F4 and F41). See FIG. 2 which depicts the preceding mappings.

The resource field tree of the base layer 401 and the sub-tree of each overlay has a unique resource key serving as a unique identification string for storing (and retrieving) the base layer 401 and each overlay layer (overlay 1, overlay 2) in the etcd database.

In one embodiment, the resource field tree of the base layer has resource key (called “base key”) “/registry/deployments/default/foo”, overlay 1 has resource key “/registry/deployments/default/foo/F3” formed by adding the first resource field F3 to the base key, and overlay 2 has key “/registry/deployments/default/foo/F4” formed by adding the first resource field F4 to the base key.

Although the preceding embodiment adds the top-level field F3 to the base key to generate a unique resource key for overlay 1, any field (F3, F31, F32) or combination of fields in the sub-tree\ of overlay 1 could be added to the base key to generate a unique resource key for overlay 1.

Although the preceding embodiment adds the top-level field F4 to the base key to generate a unique resource key for overlay 2, any field (F4, F41) or combination of fields in the sub-tree of overlay 2 could be added to the base key to generate a unique resource key for overlay 2.

In general, any field or combination of fields in the sub-tree of any overlay layer of a resource could be added to the base key of the base layer of the resource to generate a unique resource key for said any overlay layer.

In the preceding embodiment, the resource field tree of the base layer and the sub-trees of the overlays (overlay 1, overlay 2) may be stored in the etcd database using the respective resource keys via the following put commands (expressed as comments):

# etcdctl put /registry/deployments/default/foo/ <resource>;
# etcdctl put /registry/deployments/default/foo/F3 <resource_F3>;
# etcdctl put /registry/deployments/default/foo/F4 <resource_F4>.

In one embodiment, the following JSON Paths are used to construct keys for other sub-trees as indicated:

```
  /registry/deployments/default/foo # the original tree;
  /registry/deployments/default/foo/.spec.template.spec.containers[*].resources #
the sub-tree for resource overriding;
  /registry/deployments/default/foo/.spec.replicas # the sub-tree for replicas
overriding;
  /registry/deployments/default/foo/.metadata.annotations # the sub-tree for gitops
configuration overriding.
```

The preceding keys derived from the JSON paths are named in accordance with a characteristic of the respective resource (containers, replicas, gitops configuration).

FIG. 4B is a flow chart of a method for generating a layering resource representation of a resource, in accordance with embodiments of the present invention. The method of FIG. 4B includes steps 410-430. In one embodiment, the resource is a Kubernetes resource.
Step 410 creates, by an owner controller, a base layer of the layering resource representation, wherein the base layer consists of a resource field tree of the entire resource.
Step 420 creates, by the one or more collaborator controllers, respective one or more overlay layers of the layering resource representation, wherein each overlay layer consists of a sub-tree of the resource field tree. Each collaborator controller is authorized to update each field of the sub-tree created by the collaborator controller and is not authorized to update any other field of the resource field tree. Any field of the sub-tree that is updated by the collaborator controller that created the sub-tree replaces any previous updating of said any field by the owner controller.
Step 430 stores a layering resource representation of the resource, which includes the base layer and the N overlay layers, in a key-value database denoted as an etcd database. In one embodiment, the key-value database (i.e., the etcd database) is a Kubernetes key-value database.

FIG. 4C is a flow chart of a process for storing the resource as a layering resource representation of the resource in a key-value database denoted as an etcd database, in accordance with embodiments of the present invention. In one embodiment, the key-value database (i.e., the etcd database) is a Kubernetes key-value database. The process of FIG. 4C is an embodiment for implementing step 430 of FIG. 4B and includes steps 431-434.
Step 431 generates a base layer resource key that maps to the owner controller and is unique to the base layer.
Step 432 stores the base layer into a key-value database, called an etcd database, using the base layer resource key.
Step 433 generates, for overlay layer n of N overlay layers, an overlay layer resource key (Kn) that maps to the collaborator controller of overlay layer n and is unique to overlay layer n (n=1, 2, . . . , N).
Step 434 stores overlay layer n in the etcd database using the overlay layer resource key Kn that is unique to overlay layer n (n=1, 2, . . . , N).

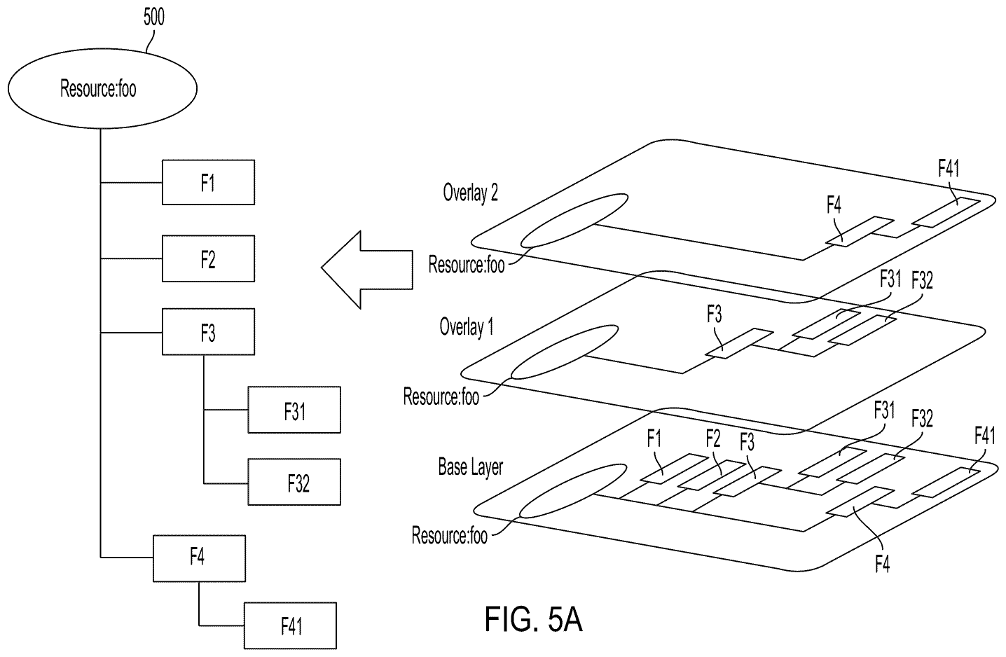

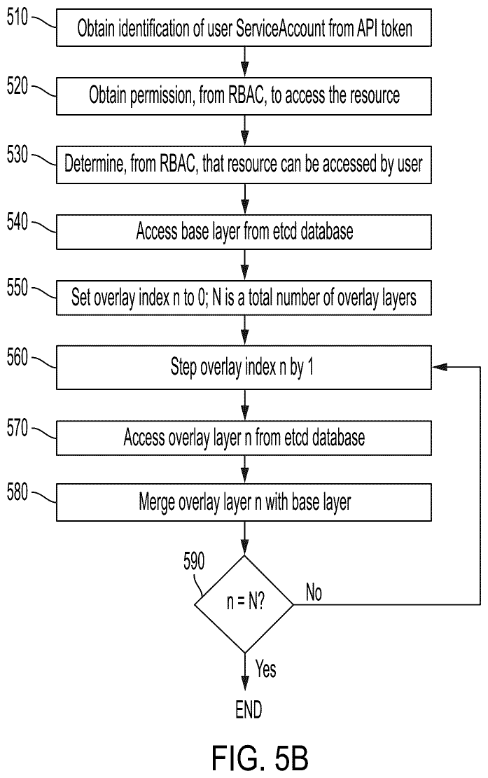

FIG. 5A depicts a process for reading a resource, in accordance with embodiments of the present invention. The sub-trees of the overlay layers (overlay 1, overlay 2) are each merged with the base layer.

The field values of fields F3, F31 and F32 in overlay 1 override the respective field values F3, F31 and F32 in the base layer, and the field values of fields F4 and F41 in overlay 2 override the respective field values F4 and F41 in the base layer, resulting in the merged resource 500 of “foo”.

FIG. 5B is a flow chart describing the process of FIG. 5A for reading the resource, in accordance with embodiments of the present invention. The process of FIG. 5A includes steps 510-590 and is initiated by an API call (Get).
Step 510 obtains an identification of a user Service Account from an API token included in the API call.
Step 520 obtains permission, from RBAC, to access the resource.
Step 530 determines, from RBAC, that the resource can be stored and accessed by the user Service Account.
Step 540 accesses the base layer from the etcd database using the base layer resource key.
Step 550 sets an overlay layer index n to 0. N is a total number of overlay layers.
Step 560 steps the overlay layer index n by 1.
Step 570 accesses overlay layer n from the etcd database using the overlay layer resource key (Kn).
Step 580 merges the sub-tree of overlay layer n with the resource field tree of the base layer, including overriding values of sub-fields in the base layer by respective sub-field values in overlay layer n.
Step 590 determines whether overlay layer n is the last overlay layer merged with the base layer (i.e., if n=N), and if so then the process ends, and if not then the process iterates by re-performing steps 560-590 for the next overlay layer n+1 until all overlays have been merged with the base layer to form the resource including all updates contained in the overlay layers.

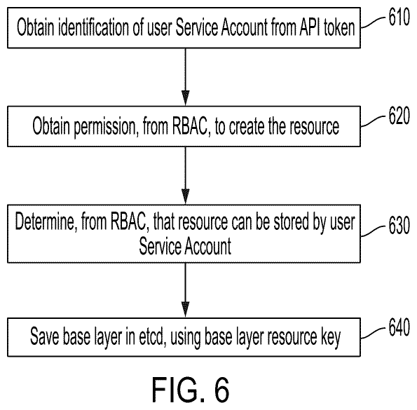

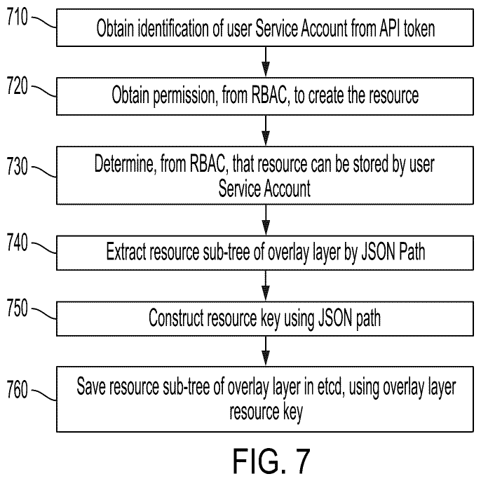

Creating and saving, into the etcd database, the layering resource representation, as described supra in conjunction with FIGS. 4B and 4C, proceeds in two stages. First, the base layer of a resource is created and saved into the etcd database as described in FIG. 6. Next after the base layer has been created and saved into the etcd database, each overlay layer of N overlay layers of the resource is created and saved into the etcd database as described in FIG. 7.

FIG. 6 is a flow chart of a process for creating, and saving into the etcd database, a base layer of a resource, in accordance with embodiments of the present invention. The process of FIG. 6 includes steps 610-640 and is initiated by an API call (POST or PUT) submitted by the owner controller that maintains the base layer.
Step 610 obtains an identification of a user Service Account from an API token included in the API call.
Step 620 obtains permission, from RBAC, to create the resource.
Step 630 determines, from RBAC, that the resource can be stored by the user Service Account.
Step 640 saves the resource in the etcd database as a base layer using the base layer resource key. Embodiments for creating the base layer resource key has been described supra in conjunction with FIG. 4C.

FIG. 7 is a flow chart of a process for creating, and saving into the etcd database, an overlay layer of a resource, in accordance with embodiments of the present invention. The process of FIG. 7 includes steps 710-760 and is initiated by an API call (PUT or PATCH) submitted by the overlay controller that controls (including updates) the overlay layer. The API call is initiated after the base layer for the resource has been created and stored in the etcd database, in response to a need for modifying one or more resource fields that exist in the overlay layer.
Step 710 obtains an identification of a user Service Account from an API token included in the API call.
Step 720 obtains permission, from RBAC, to create the resource.
Step 730 determines, from RBAC, that the resource can be stored by the user Service Account.
Step 740 extracts the resource sub-tree of the overlay layer from a JSON path defined in RBAC rules.
Step 750 constructs the overlay layer resource key for the overlay layer, using the JSON path defined in RBAC rules.
Step 760 saves the extracted resource sub-tree of the overlay layer in the etcd database, using the overlay layer resource key.

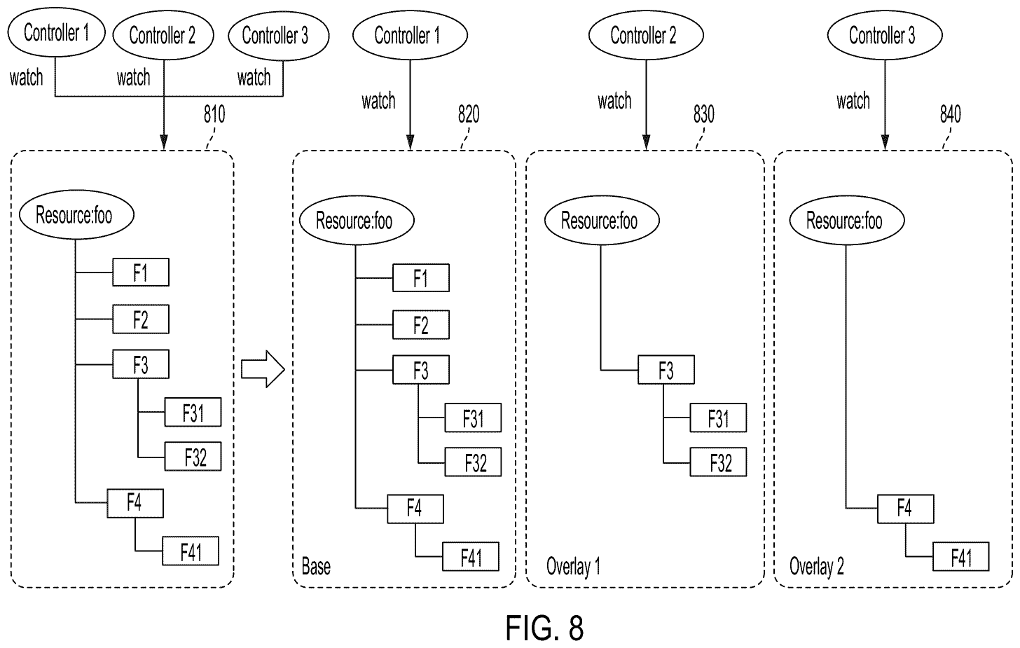

FIG. 8 is a diagram describing detection of changes in the resource using the etcd Watch function, in accordance with embodiments of the present invention. Embodiments of the present invention employ the etcd Watch function to watch (i.e., monitor) the base layer and overlay layers for changes in the base layer and overlay layers.

The resource “foo” 810, which exists before the layering resource representation is introduced, is watched by three controllers (Controller 1, Controller 2, Controller 3) simultaneously, which leads to conflict between the controllers.

The layering resource representation comprises: the base layer 820 which encompasses the entire resource “foo” and is watched by Controller 1 which is an owner controller that controls the base layer 820; overlay layer 1 which encompasses the sub-tree 830 and is watched by Controller 2 which controls overlay layer 1 of the resource “foo”; and; overlay layer 2 which encompasses the sub-tree 840 and is watched by Controller 3 which controls overlay layer 2 of the resource “foo”.

With the layering resource representation, changes to the resource including changes for the base layer and the overlay layers are watched independently by different controllers. Each change triggers only one controller without interfering with other controllers and still relies on the etcd ‘Watch’ mechanism. Thus, conflict is avoided with the layering resource representation.

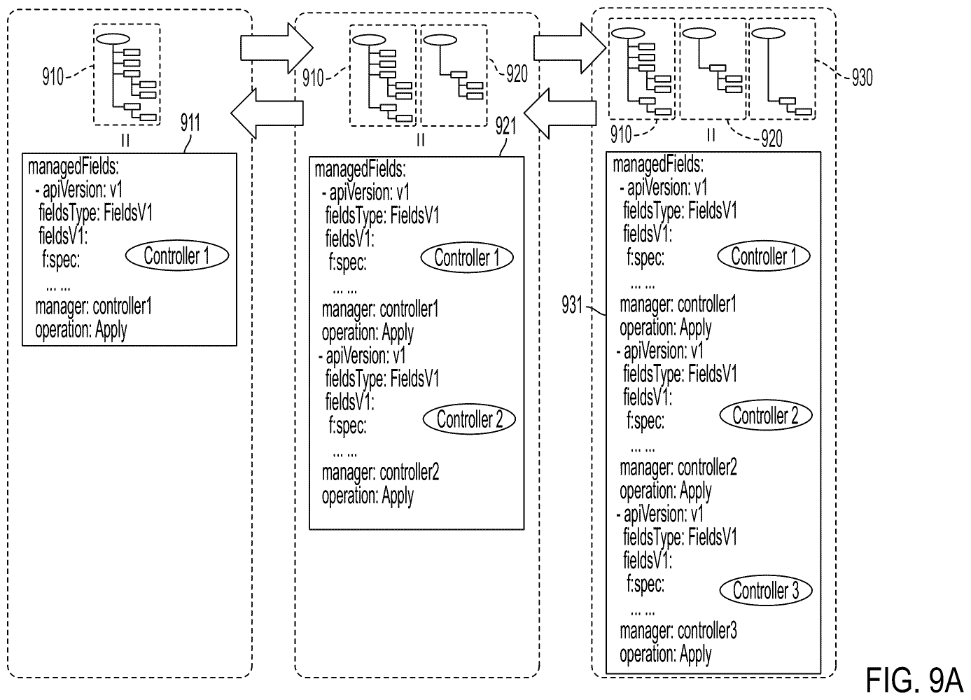

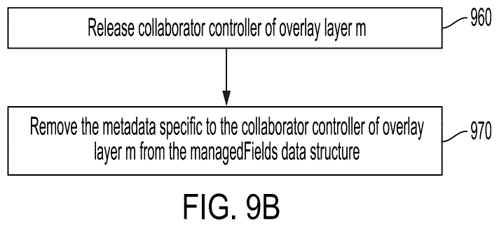

FIG. 9A is a diagram illustrating tracking of the layering resource representation lifecycle pertaining to deleting overlay layers of the resource, in accordance with embodiments of the present invention. Deletion of the overlay layers is accomplished by inserting metadata within a managedFields data structure (e.g., in Kubernetes). The metadata that is added to the managedFields data structure is novel, unobvious, and specific to controllers that control the base layer and the overlay layers.

In a scenario in which only the base layer 910 of the entire resource exists (i.e., the overlay layers do not exist), a current managedFields data structure is a managedFields data structure 911 which includes metadata of “manager: controller 1” that is specific to controller 1 which is the owner controller that controls the base layer 910.

After overlay 1, which encompasses the sub-tree 920, has been added to the base layer 910, the current managedFields data structure is a managedFields data structure 921 which includes metadata of “manager: controller1” that is specific to controller 1 and “manager: controller2” that is specific to controller 2 that controls overlay 1.

After overlay 2, which encompasses the sub-tree 930, has been added to both the base layer 910 and overlay 1, the current managedFields data structure is a managedFields data structure 931 which includes metadata of “manager: controller1” that is specific to controller 1, “manager: controller2” that is specific to controller 2, and “manager: controller3” that is specific to controller 3 that controls the overlay 2.

If controller 3 is released, then the controller 3 is removed from the metadata and the current mangedFields data structure is the managedFields data structure 921 which includes metadata of “manager: controller1” that is specific to controller 1 and “manager: controller2” that is specific to controller 2, but does not include “manager: controller3” that is specific to controller 3 due to controller 3 having been released (i.e., release of control of the corresponding resource fields that are being controlled by the controller 3). In one embodiment, the controller 3 releases itself. In one embodiment, a system administrator releases controller 3.

Following the release of controller 3, if controller 2 is released, then the controller 2 is removed from the metadata and the current structure is the managedFields data structure 911 which includes metadata of “manager: controller1” that is specific to controller 1.

Following the release of controller 2, if controller 1, which is the owner controller, is released, then the controller 1 is removed from the metadata and the whole resource is deleted completely from the etcd database.

FIG. 9B is a flow chart describing a process of releasing a collaborator controller, in accordance with embodiments of the present invention. In the process of FIG. 9B, which includes steps 960 and 970, a managedFields data structure (e.g., a Kubernetes managedFields data structure) includes metadata specific to the owner controller and metadata specific to the collaborator controller of overlay layer m, wherein m is selected from the group consisting of 1, 2, . . . , and N.
Step 960 releases the collaborator controller of overlay layer m.

In response to releasing the collaborator controller of overlay layer m, step 970 removes the metadata specific to the collaborator controller of overlay layer m from the managedFields data structure.

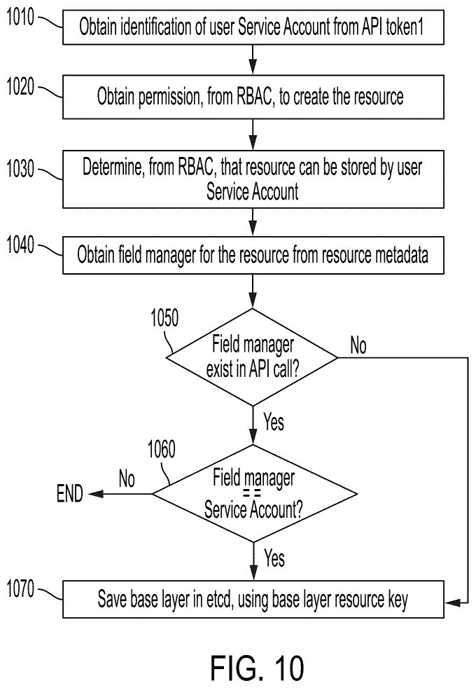

FIG. 10 is a flow chart of a process for conditionally creating, and saving into the etcd database, a base layer of a resource, in accordance with embodiments of the present invention. The process of FIG. 10 includes steps 1010-1070 and is initiated by an API call (POST or PUT) submitted by the owner controller that controls the base layer.
Step 1010 obtains an identification of a user Service Account from an API token included in the API call.
Step 1020 obtains permission, from RBAC, to create the resource.
Step 1030 determines, from RBAC, that the resource can be stored by the user Service Account.
Step 1040 obtains a field manager for the resource from the resource metadata.
Step 1050 determines whether the field manager exists in the API call, and if so then step 1060 is next executed, and if not then step 1070 is next executed.
Step 1060 determines whether the field manager in the API call equals the user Service Account, and if so then step 1070 is next executed, and if not then the process ends.
Step 1070 saves the resource in the etcd database as a base layer using the base layer resource key. Embodiments for creating the unique key for the base layer has been described supra in conjunction with FIG. 4.

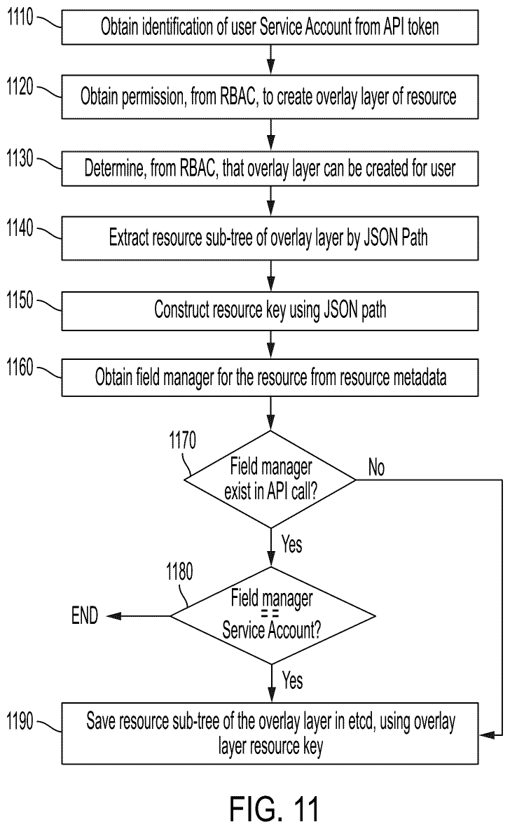

FIG. 11 is a flow chart of a process for conditionally creating, and saving into the etcd database, an overlay layer of a resource, in accordance with embodiments of the present invention. The process of FIG. 7 includes steps 1110-1190 and is initiated by an API call (PUT or PATCH) submitted by the collaborator controller that controls the overlay layer. The API call is initiated after the base layer for the resource has been created and stored in the etcd database, in response to a need for modifying one or more resource fields that exist in the overlay layer.
Step 1110 identifies a user Service account from an API token included in the API call.
Step 1120 obtains permission, from RBAC, to create the overlay layer of the resource as an update of one or more fields of the base layer of the resource.
Step 1130 determines, from RBAC, that the resource can be stored by the user Service Account.
Step 1140 extracts the sub-tree of the overlay layer from the JSON path defined in RBAC rules.
Step 1150 constructs the overlay layer resource key for the overlay layer, using the JSON path defined in RBAC rules.
Step 1160 obtains a field manager for the resource from the resource metadata.
Step 1170 determines whether the field manager exists in the API call, and if so then step 1180 is next executed, and if not then step 1190 is next executed.
Step 1180 determines whether the field manager in the API call equals the user Service Account, and if so then step 1190 is next executed, and if not then the process ends.
Step 1190 save resource sub-tree in the etcd database as an overlay layer, using the overlay layer resource key. Embodiments for creating the unique key for the overlay layer has been described supra in conjunction with FIG. 4.

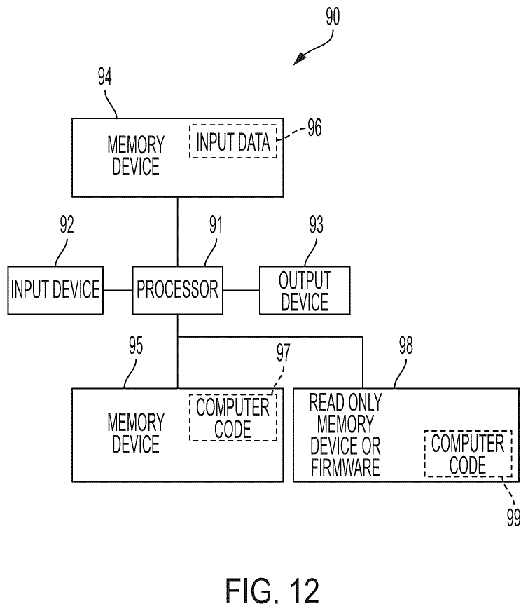

FIG. 12 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 12 shows the computer system 90 as a particular configuration of hardware and software, any configuration of hardware and software, as would be known to a person of ordinary skill in the art, may be utilized for the purposes stated supra in conjunction with the particular computer system 90 of FIG. 12. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

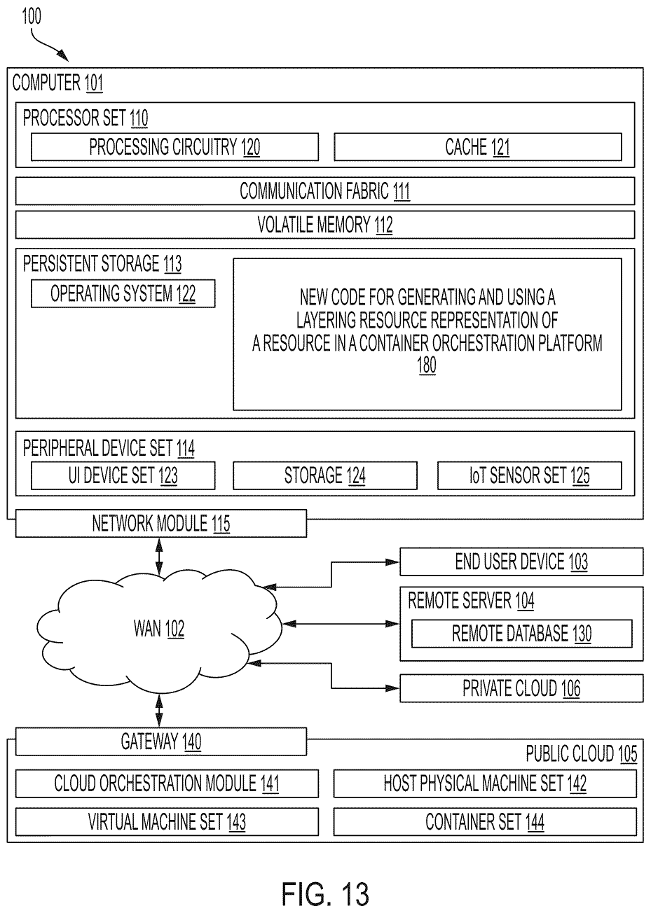

FIG. 13 depicts a computing environment 100 which contains an example of an environment for the execution of at least some of the computer code involved in performing the inventive methods, in accordance with embodiments of the present invention. Such computer code includes new code generating and using a layering resource representation of a resource in a container orchestration platform 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 13. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It should be appreciated that while some illustrative embodiments have been described herein with reference to a Kubernetes platform as an example container orchestration platform with which the mechanisms of the illustrative embodiments are utilized, the illustrative embodiments are not limited to a Kubernetes platform. To the contrary, the illustrative embodiments may be implemented and operate with any currently known or later developed container orchestration platforms without departing from the spirit and scope of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating and using a layering resource representation of a resource in a container orchestration platform, said method comprising:
creating, by an owner controller using one or more processors of a computer system, a base layer of the layering resource representation, wherein the base layer consists of a resource field tree of the entire resource; and
after said creating the base layer, creating, by one or more collaborator controllers using the one or more processors, respective one or more overlay layers of the layering resource representation, wherein each overlay layer consists of a sub-tree of the resource field tree,
wherein each collaborator controller is authorized to update each field of the sub-tree created by said each collaborator controller and is not authorized to update any other field of the resource field tree, and
wherein any field of the sub-tree that is updated by the collaborator controller that created the sub-tree replaces any previous updating of said any field by the owner controller.

2. The method of claim 1, wherein the one or more overlay layers consist of N overlay layers, wherein N is at least 1, and wherein the method further comprises: storing, by the one or more processors, the layering resource representation of the resource in a key-value database denoted as an etcd database, said storing the layering resource representation of the resource comprising:
generating a base layer resource key that maps to the owner controller and is unique to the base layer;
storing the base layer into the etcd database, using the base layer resource key;
generating, for overlay layer n of N overlay layers, an overlay layer resource key (Kn) that maps to the collaborator controller of overlay layer n and is unique to overlay layer n (n=1, 2, . . . , N);
storing overlay layer n in the etcd database using the overlay layer resource key (Kn) (n=1, 2, . . . , N).

3. The method of claim 2, wherein said storing the base layer into the etcd database is initiated by a Application Programming Interface (API) call, and wherein said storing the base layer into the etcd database comprises:
obtaining an identification of a user Service Account from an API token included in the API call;
obtaining permission, from Role-Based Access Control (RBAC), to create the resource;
determining, from RBAC, that the resource can be stored by the user Service Account;
saving the resource in the etcd database as the base layer using the base layer resource key.

4. The method of claim 3, wherein the method further comprises after said determining that the resource can be stored by the user Service Account and before said saving the resource in the etcd database as the base layer:
obtaining a field manager for the resource from resource metadata;
determining either that the field manager exists in the API call and that the field manager in the API call equals the user Service Account or that the field manager does not exist in the API call.

5. The method of claim 2, wherein said storing overlay layer n (n=1, 2, . . . , N) in the etcd database is initiated by a Application Programming Interface (API) call, and wherein said storing overlay layer n into the etcd database comprises:
obtaining an identification of the user Service Account from an API token included in the API call;
obtaining permission, from Role-Based Access Control (RBAC), to create the resource;
extracting a sub-tree of overlay layer n from a JavaScript Object Notation (JSON) path defined in RBAC rules;
constructing the overlay layer resource key (Kn) for overlay layer n, using the JSON path defined in RBAC rules;
saving the resource sub-tree in the etcd database as overlay layer n, using the overlay layer resource key (Kn).

6. The method of claim 5 wherein the method further comprises after said constructing the overlay layer resource key (Kn) for overlay layer n and before said saving the resource sub-tree in the etcd database
obtaining a field manager for the resource from resource metadata;
determining either that the field manager exists in the API call and that the field manager in the API call equals the user Service Account or that the field manager does not exist in the API call.

7. The method of claim 2, said method further comprising: reading, by a user Service Account, using the one or more processors, the resource from the etcd database, said reading the resource being initiated by an Application Programming Interface (API) call and comprising:
obtaining an identification of the user Service Account from an API token included in the API call;
obtaining permission, from Role-Based Access Control (RBAC), to access the resource;
determining, from RBAC, that the resource can be accessed by the user Service Account;
accessing the base layer from the etcd database using the base layer resource key;
for n=1, 2, . . . , N:
accessing overlay layer n from the etcd database using the overlay layer resource key (Kn);
merging overlay layer n with the base layer, including overriding values of sub-fields in the base layer by respective sub-field values in overlay layer n.

8. The method of claim 2, said method further comprising:
employing, by the owner controller and the collaborator controller authorized to update the resource fields of overlay layer n using the one or more processors, an etcd Watch function to independently monitor the base layer and overlay layer n for changes in the base layer and the overlay layer n, respectively (n=1, 2, . . . , N).

9. The method of claim 2, wherein a managedFields data structure includes metadata specific to the owner controller and metadata specific to the collaborator controller of overlay layer m (n=1, 2, . . . , N), and wherein the method further comprises:
releasing, by the one or more processors, the collaborator controller of overlay layer m, wherein m is selected from the group consisting of 1, 2, . . . , and N; and
in response to said releasing, removing, by the one or more processors, the metadata specific to the collaborator controller of overlay layer m from the managedFields data structure.

10. The method of claim 1, wherein the one or more overlay layers consist of two or more overlay layers, and wherein the two or more overlay layers are mutually exclusive with respect to the fields in the two or more overlay layers.

11. The method of claim 1, wherein an extension to a Role-Based Access Control (RBAC) includes a field that defines each collaborator controller and authorizes each collaborator controller to update, by patching, the fields of the sub-tree that each collaborator controller creates.

12. The method of claim 11, wherein the method further comprises:
role binding, by the one or more processors, a user Service Account to a controller role of one of the collaborator controllers via metadata that links the user Service Account to the controller role.

13. The method of claim 1, wherein the container orchestration platform comprises a Kubernetes platform.

14. A computer program product, comprising one or more computer readable hardware storage devices having computer readable program code stored therein, said program code containing instructions executable by one or more processors of a computer system to implement a method for generating and using a layering resource representation of a resource in a container orchestration platform, said method comprising:
creating, by an owner controller using the one or more processors, a base layer of the layering resource representation, wherein the base layer consists of a resource field tree of the entire resource; and
after said creating the base layer, creating, by one or more collaborator controllers using the one or more processors, respective one or more overlay layers of the layering resource representation, wherein each overlay layer consists of a sub-tree of the resource field tree,
wherein each collaborator controller is authorized to update each field of the sub-tree created by said each collaborator controller and is not authorized to update any other field of the resource field tree, and
wherein any field of the sub-tree that is updated by the collaborator controller that created the sub-tree replaces any previous updating of said any field by the owner controller.

15. The computer program product of claim 14, wherein the one or more overlay layers consist of N overlay layers, wherein N is at least 1, and wherein the method further comprises: storing, by the one or more processors, the layering resource representation of the resource in a key-value database denoted as an etcd database, said storing the layering resource representation of the resource comprising:
generating a base layer resource key that maps to the owner controller and is unique to the base layer;
storing the base layer into the etcd database, using the base layer resource key;
generating, for overlay layer n of N overlay layers, an overlay layer resource key (Kn) that maps to the collaborator controller of overlay layer n and is unique to overlay layer n (n=1, 2, . . . , N);
storing overlay layer n in the etcd database using the overlay layer resource key (Kn) (n=1, 2, . . . , N).

16. The computer program product of claim 15, wherein said storing the base layer into the etcd database is initiated by a Application Programming Interface (API) call, and wherein said storing the base layer into the etcd database comprises:
obtaining an identification of a user Service Account from an API token included in the API call;
obtaining permission, from Role-Based Access Control (RBAC), to create the resource;
determining, from RBAC, that the resource can be stored by the user Service Account;
saving the resource in the etcd database as the base layer using the base layer resource key.

17. The computer program product of claim 15, wherein said storing overlay layer n (n=1, 2, . . . , N) in the etcd database is initiated by a Application Programming Interface (API) call, and wherein said storing overlay layer n into the etcd database comprises:
obtaining an identification of the user Service Account from an API token included in the API call;
obtaining permission, from Role-Based Access Control (RBAC), to create the resource;
extracting a sub-tree of overlay layer n from a JavaScript Object Notation (JSON) path defined in RBAC rules;
constructing the overlay layer resource key (Kn) for overlay layer n, using the JSON path defined in RBAC rules;
saving the resource sub-tree in the etcd database as overlay layer n, using the overlay layer resource key (Kn).

18. The computer program product of claim 14, wherein the container orchestration platform comprises a Kubernetes platform.

19. A computer system, comprising one or more processors, one or more memories, and one or more computer readable hardware storage devices, said one or more hardware storage devices containing program code executable by the one or more processors via the one or more memories to implement a method for generating and using a layering resource representation of a resource in a container orchestration platform, said method comprising:
creating, by an owner controller using the one or more processors, a base layer of the layering resource representation, wherein the base layer consists of a resource field tree of the entire resource; and
after said creating the base layer, creating, by one or more collaborator controllers using the one or more processors, respective one or more overlay layers of the layering resource representation, wherein each overlay layer consists of a sub-tree of the resource field tree,
wherein each collaborator controller is authorized to update each field of the sub-tree created by said each collaborator controller and is not authorized to update any other field of the resource field tree, and
wherein any field of the sub-tree that is updated by the collaborator controller that created the sub-tree replaces any previous updating of said any field by the owner controller.

20. The computer system of claim 19, wherein the one or more overlay layers consist of N overlay layers, wherein N is at least 1, and wherein the method further comprises: storing, by the one or more processors, the layering resource representation of the resource in a key-value database denoted as an etcd database, said storing the layering resource representation of the resource comprising:
generating a base layer resource key that maps to the owner controller and is unique to the base layer;
storing the base layer into the etcd database, using the base layer resource key;
generating, for overlay layer n of N overlay layers, an overlay layer resource key (Kn) that maps to the collaborator controller of overlay layer n and is unique to overlay layer n (n=1, 2, . . . , N);
storing overlay layer n in the etcd database using the overlay layer resource key (Kn) (n=1, 2, . . . , N).
